(19) United States
(12) Patent Application Publication
(10) Pub. No.: US 2006/0059260 A1
(43) Pub. Date: Mar. 16, 2006

(54) Recommendation of media content on a media system

(75) Inventors: Declan Patrick Kelly, Eindhoven (NL); Jozef Pieter Van Gassel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electrics N.V., Eindhoven (NL)

(21) Appl. No.: 10/514,590

(22) PCT Filed: Apr. 22, 2003
(86) PCT No.: PCT/IB03/01676

§ 371 Date: Nov. 16, 2004

(30) Foreign Application Priority Data
May 21, 2002 (EP) 02076979.0

(51) Int. Cl. G06F 15/173

(52) U.S. Cl. 709/225

(57) ABSTRACT

A method, a media system of/for recommending media content on the media system (103) by use of a first set (300) of preference profiles stored on the media system and a second set (301) of preference profiles stored on a server (101), wherein each preference profile of said two sets of preference profiles comprises preferred media content saved with characteristics of a community on the server, and saved with characteristics of a user on the media system. The media system can be a TV, a computer, a personal video recorder, a set-top box or a radio. The media content can be TV, video, a radio broadcasting, Internet or Internet sites. The community characteristics can be a community name, a profession, an employer, a department of the employer, a group, a sub-group, a region of living, a sex, sexual preferences, etc. The preferred media content can be categories such as comedy, horror, sport, opera, news, etc. The method includes the steps of: transferring a selected first community characteristics (105) to the server from the media system; determining, on the server, a third set of preference profiles (302) with a third preferred media content from the second set of preference profiles, wherein the third set has characteristics matching the received first community characteristics; transferring the third set of preference profiles from the server to the media system in response to the received first community characteristics; and recommending media

This invention relates to a method of recommending media content on a media system by use of a first set of preference profiles stored on the media system and a second set of preference profiles stored on a server.

The present invention also relates to a computer system for performing the method.

The present invention further relates to a computer program product for performing the method.

Additionally, the present invention also relates to a media system for recommending media content by use of a first set of preference profiles stored on the media system and a second set of preference profiles stored on a server.

WO 00/6223 discloses a web-based system for assisting of customers in selecting products or other types of items from an electronic catalog of a merchant. The customers are assisted in their selection by means of a transferred list, where the transferred list can comprise information about items, which are popular within a community.

It is common to people sharing a community that these people may to some extent wish also to watch a media content also preferred by the other people in the community. It is known to receive a list—similar to, as discussed above—from a system where the list contains what the system believes would be of interest to the user of a selected community. However, the user may have been mismatched to the given community since only a limited number of communities can be selected, and—as a consequence of the mismatch—said list transferred to the user may only partly reflect the interest of the user with respect to preferred media content.

It is a problem that it is not possible for users of media systems, such as a TV, a computer, a personal video, etc, to benefit from the recommendations given by a combined list made to purpose of what media content to watch.

It is therefore an object of the invention from a defined set of one or more communities to use the profiles associated to these communities in order to obtain a recommendation of media content on the media system.

The above problem is solved by said method, when each preference profile of said two sets of preference profiles comprises preferred media content saved with characteristics of a community on the server, and saved with characteristics of a user on the media system, and where method comprises the steps of:
transferring a selected first community characteristics to the server from the media system;
determining, on the server, a third set of preference profiles with a third preferred media content from the second set of preference profiles, wherein the third set has characteristics matching the received first community characteristics;
transferring the third set of preference profiles from the server to the media system in response to the received first community characteristics; and
recommending media content on the media system based on the third preferred media content of the received third set of preference profiles, based on, optionally, the first preferred media content of the first set of preference profiles stored on the media system and a media content available to the media system.

In the first step—by means of said community characteristics—the user can set up a selection criterion for possibly interesting characteristics of communities.

In the second step—by means of said community characteristics—the server may determine a new (third) set of preference profiles with a third preferred media content matching the received community characteristics.

In the third step, the new (third) set of preference profiles is sent to the media system.

Finally, these are use to recommend media content to the user of the media system.

Hereby, the object is achieved of obtaining a recommendation of media content on the media system, since the selected profiles are defined by said community characteristics, and said profiles are then subsequently used on the media system to recommend media content.

In a preferred embodiment of the method, the method further comprises the step of:
storing the received third set of preference profiles on the media system to the first set of preference profiles.

When the user of the media system in the foregoing steps determines that the recommendation based on the received third set of preference profiles was satisfactory, he may then choose to save these to the first set of preference profiles on his media system.

In another preferred embodiment of the method, the method further comprises the step of:
modifying and storing the first set of preference profiles.

The user may be dissatisfied with the recommendation given and may—as an example—transfer some media content to a disliked category and vice versa It is hereby an advantage of the invention that the user of the media system has the possibility of amending his preference profiles in order to obtain another recommendation in the future on his media system.

In another preferred embodiment of the method, the method further comprises the sub-steps of:
sending an information property, on the basis of a user input on the media system, to the server;
determining, on the server, a fourth set of preference profiles comprising a fourth preferred media content, wherein the fourth preferred media content is generated on basis of said information property and the second set of preference profiles stored on the server;
transferring the fourth preference profile from the server to the media system to the first set of preference profiles stored on the media system in response to the received information property; and
recommending further media content on the media system based on the fourth preferred media content of the received fourth preference profile and the media content available to the media system.

In these four steps, firstly said information property is used similarly to the very first step, and the following steps; the information property may in the second step be used to manipulate and to filter the second set of preference profiles on the server in order to determine a fourth preferred media content for a subsequent transfer—in the third step—to the media system, and subsequently—in the fourth step—to recommend further media content on the media system.

The information property may instruct the server that some preference profiles are compared to other preference profiles in order to give more or less weight, to override, to invert data, etc, comprised in these profiles.

In a preferred embodiment of the invention, the media system may be a TV, a computer, a personal video recorder, a set-top box or a radio.

In a preferred embodiment of the invention, the media content may be TV, video, a radio broadcasting, Internet TV or Internet sites.

Previously mentioned problem is further solved by a media system for recommending media content by use of a first set of preference profiles stored on the media system and a second set of preference profiles stored on a server, said media system comprising:
means for transferring a selected first community characteristics to the server;
means for receiving, determined on the server, a third set of preference profiles with a third preferred media content from the second set of preference profiles, wherein the third set has characteristics matching the received first community characteristics; and
means for recommending media content based on the third preferred media content of the received third set of preference profiles, based on, optionally, the first preferred media content of the first set of preference profiles stored on the media system and a media content available to the media system.

In a preferred embodiment of the invention, said media system further comprises:
means for storing the received third set of preference profiles system to the first set of preference profiles.

In another preferred embodiment of the invention, said media system further comprises:
means for sending an information property, on the basis of a user input, to the server;
means for receiving, determined on the server, a fourth set of preference profiles comprising a fourth preferred media content, wherein the fourth preferred media content is generated on basis of said information property and the second set of preference profiles stored on the server; and
means for recommending further media content based on the fourth preferred media content of the received fourth preference profile.

The media system gives the same advantages for the same reasons as described previously in relation to the method.

The invention will be explained more fully below in connection with preferred embodiments and with reference to the drawings, in which:

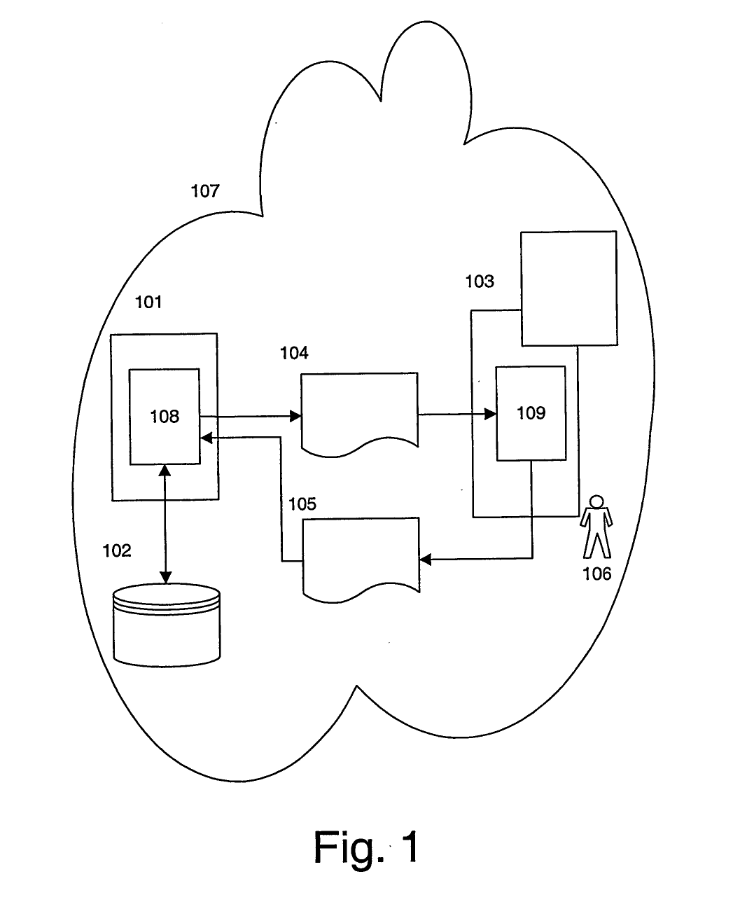

FIG. 1 shows a system with a server, media systems, a user and the flow of information;

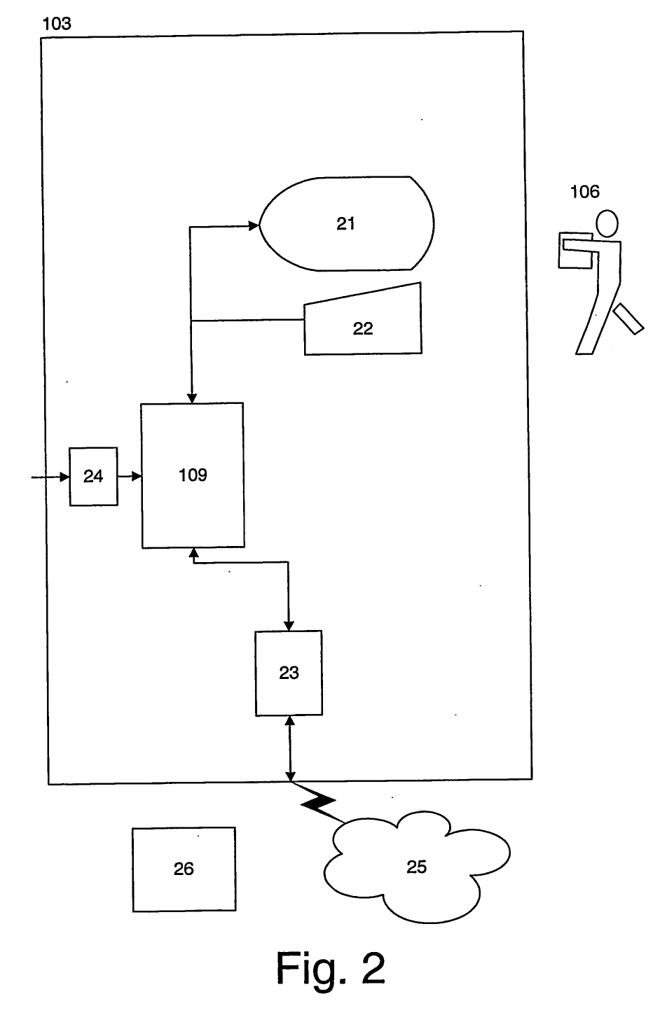

FIG. 2 shows the media system and a computer program product;

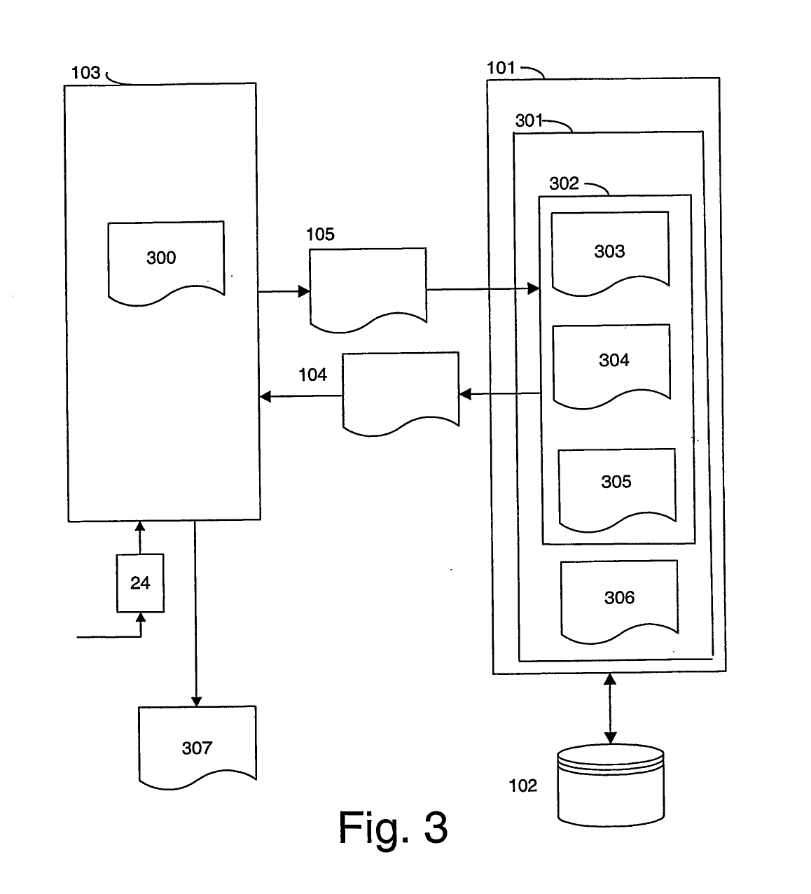

FIG. 3 shows the server, the media system, a detailed flow of information, preference profile and recommendation of media content; and

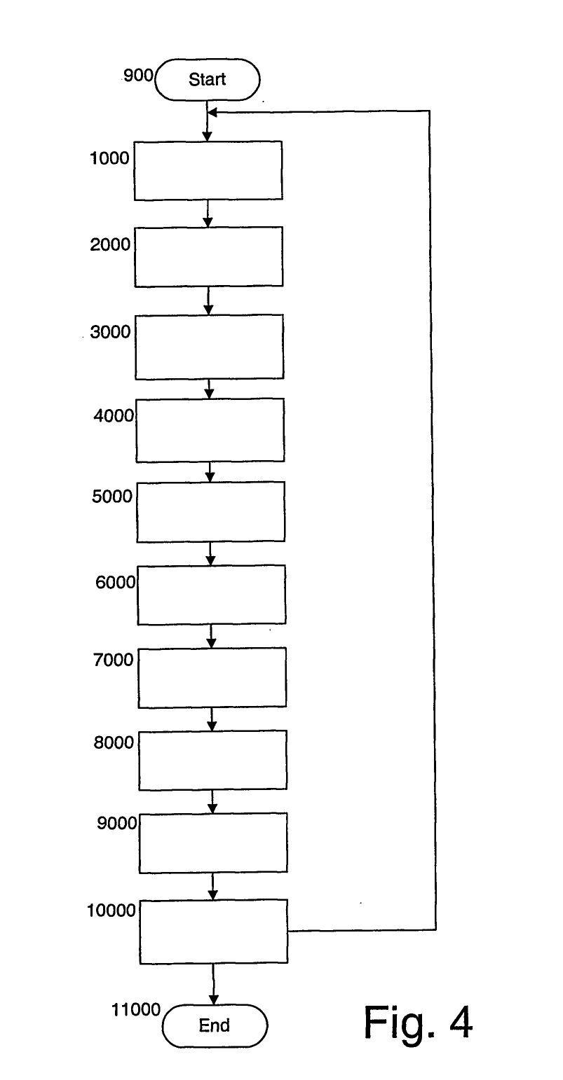

FIG. 4 shows a method of recommending media content on the media system by use of preference profiles stored on the media system and by use of other preference profiles stored on the server.

Throughout the drawings, the same reference numerals indicate similar or corresponding features, functions, etc.

FIG. 1 shows a system with a server, media systems, a user and the flow of information.

In a preferred embodiment of the invention, the method of the invention (FIG. 4) is executed on one or more media systems and a server.

Reference numeral 101 may be a server. The server is mainly the controlling part of the system The server may be accessed by various media systems as shown by reference numeral 103. The server comprises means for connection to the Internet with a possibility to be accessed simultaneously by various media systems using the service of the server, which is provided by the method of FIG. 4.

Reference numeral 103 may be the media system. The media system may be used as the connection point to a user, reference numeral 106, using the method of FIG. 4. There may be more media systems simultaneously accessing the server via the Internet or any other open network, reference numeral 107. The various media systems are designated by the two rectangles of reference numeral 103.

Reference numeral 104 may generally represent information of the method sent from the server to the media system by means of reference numeral 107. The said information may typical comprise preference profiles based on a selection criterion, e.g. a community characteristic as the selection criterion (typed in) on the media system

The server may have a connection to a database, which is shown by reference numeral 102. The database may comprise various information about preference profiles and which media systems and which type of the media system that are accessing said server.

The reference numeral 105 may generally be information sent from the media system(s) to the server also by means of reference numeral 107, e.g. said community characteristics.

When discussing preference profiles on the media system they comprise preferred media content saved with characteristics of the user, reference numeral 106, and when discussing preference profiles on the server the preference profiles also comprise preferred media content but here with characteristics of a community instead of characteristics of the user.

The community characteristics may comprise information such as a profession, a common employer, a common department of the employer group, a sub-group, a region of living, a region of origin, an age, a sex, a sexual preference, a school, a union, a sport, a leisure activity, a location (e.g. a country, a city), etc.

The characteristics of the user may be compared and defined similar to the community characteristics, but on primarily a one person level opposed to the more group oriented level of the community characteristics.

The preferred media content may comprise categories such as comedy, horror, sport, opera, news, etc. The preferred media content may further comprise disliked categories.

Reference numeral 106 may be the user at the media system's site. The user may use the media system to have media content presented and in a preferred embodiment of the invention—as will be discussed in FIG. 4—to have media content recommend to him.

Reference numeral 107 may be an open network. The network may be the Internet or any other hard- or non hard-wired connection known to enable communication between devices on an open network, wherein the devices are said server and said media systems.

Reference numeral 108 may be a processor of the server. It may be used—as will be shown in FIG. 4—to select the appropriate preference profiles based on a selection criterion for a subsequently download on the media system.

Correspondingly, reference numeral 109 may be the processor of the media system. Said processor may be used to receive said preference profiles, reference numeral 105 and the processor may subsequently be used to determine—based on one or more of said preference profiles—recommendable media content to the media system.

FIG. 2 shows the media system and a computer program product. The media system is shown by reference numeral 103. A user as indicated by reference numeral 106 may operate the media system and have various information such as a media content presented on the media system. The media content may be a live content like a TV program, a video available to be seen on demand, an interactive live broadcasted TV on the Internet, Internet TV, Internet sites only available when, e.g. a certain event is happening, a movie, radio broadcastings or any other media content which may be watched during the broadcast or said media content may be recorded, i.e. stored on the media system, for a later presentation, i.e. a later playback. During the operation of the media system the user may have information presented as indicated by reference numeral 21 on a display. The user may respond to an instruction given by the display by means of an input device as shown by reference numeral 22. The input device may be a keyboard, fields sensitive to touch, a mouse, etc. The media system of reference numeral 103 may further have the processor, as also previously indicated by reference numeral 109. The processor is arranged to receive inputs from the input device and by means of a connection, e.g. the Internet connection as indicated in reference numeral 23. The Internet connection may be used to transmit information from the media system—via the Internet, reference numeral 25—to a server and vice versa. The processor may then present various information by means of the display. The processor is further arranged to receive inputs from reference numeral 24, a device designed to receive various kinds of media content from various sources. The device, reference numeral 24 may be connected to a connection point such as an antenna inlet for TV, radio or a satellite receiver, a SCART to a TV or to a VCR, etc. -. The media content—when the media system is a personal computer, a lab-top, etc—may also be received from 25, the Internet connection, e.g. via a modem, ADSL, xDSL or the like.

Generally, when the processor is arranged to receive inputs from said devices of and by means of the Internet connection, it may further be used to perform steps of a method described in FIG. 4, where the media system is involved.

The computer program product is shown by means of reference numeral 26. The computer program product may be designed to perform the steps of the method that will be described by means of FIG. 4.

A computer readable medium may be magnetic tape, optical disc, digital video disk (DVD), compact disc (CD record-able or CD write-able), mini-disc, hard disk, floppy disk, smart card, PCMCIA card, etc.

FIG. 3 shows the server, the media system, a detailed flow of information, preference profiles on the server and on the media system, respectively, and recommendation of media content on the media system. FIG. 3 can be compared to FIG. 1, but—in a preferred embodiment of the invention—with more details about the preference profiles contained in the server.

Reference numeral 300 may be the preference profile(s) stored on the media system, and correspondingly reference numerals 303 through 306 may be the preference profiles stored on the server. Reference numeral 302 indicates one subgroup of preference profiles, whereas reference numeral 301 indicates all preference profiles available on the server. The preference profiles contained in reference numerals 300 through 306 may vary in numbers—only a few are shown for illustrative purposes. As discussed in FIG. 1, reference numerals 104 and 105 illustrate information sent between the server and one or more media systems. Reference numeral 307 may be the recommendation of media content determined on the media system based on one or more preference profiles used in the determination.

In particular, how and why the preference profile(s) is/are stored on the media system, how to recommend and how the preference profiles, reference numeral 301 through 306 are selected on the server will be shown in the next figure.

FIG. 4 shows a method of recommending media content on the media system by use of preference profiles stored on the media system and by use of other preference profiles stored on the server. The method uses—as generally shown in FIG. 3—the first set of preference profiles, reference numeral 300, stored on the media system and the second set of preference profiles, reference numeral 301 stored on the server, reference numeral 101 to, altogether or to some extent, to recommend media content on the media system.

The first set of preference profiles comprises preferred media content saved with characteristics of the user, reference numeral 106, on the media system and the second set of preference profiles also comprises preferred media content, and—as opposed to characteristics of the user—with characteristics of a community on the server.

As previously discussed, community characteristics may comprise information such as a profession, a common employer, a common department of the employer group, a sub-group, a region of living, a region of origin, an age, an age interval, a sex, a sexual preference, a school, a union, a sport, a leisure activity, a location (e.g. country, city), etc.

The characteristics of the user is primarily on one user level as opposed to the more group oriented level of said community characteristics.

The preferred media content may comprise categories such as comedy, horror, sport, opera, news, etc. The preferred media content may further comprise disliked categories.

In step 900, the method is started. Variables, flags, buffers, etc. keeping track of preference profiles on the media system and the server are set to default states and status of their corresponding processors, reference numerals 108 and 109. When the method is started a second time, only corrupted variables, flags, buffers, preference profiles, community and user characteristics, etc, are reset to default values.

In step 1000, a selected first community characteristic may be transferred to the server from the media system. The user of the media system can have an interest in what other communities' preference profiles might suggest to watch (as will be explained in step 4000, where a media content recommendation on the media system is determined). The user can therefore—in this step—select any community characteristics—(and also for a community to which the user does not belong). For an instance the user may desire to see what lawyers' communities preference profiles might recommend—so—in this case the user may have set the selected first community characteristics to ‘lawyers’. It may be the case that other words may be used to further to define the community characteristics, e.g. age=25, i.e. the selected first community would mean “young lawyers”.

Generally, the selected first community characteristics may be described and defined by use of one or more characterizing words such as: community name, profession, employer, department of the employer, group, sub-group, region of living, region of origin, school, union, sport, leisure activity, specialty of media system, disabled, profession (e.g. Information Technology worker, lawyer, engineer, baker, carpenter, etc), housewife, husband, location (e.g. country, city), age (teenager, middleaged, retired), handicapped, sex, sexual preferences, etc.

In step 2000, a third set of preference profiles with a third preferred media content from the second set of preference profiles may be determined on the server. The third set of preference profiles may be determined to have characteristics that match the first community characteristics received.

The third set of preference profiles with the corresponding third preferred media content has the same structure (but of course, with another detailed content) as the second set of preference profiles, i.e. each of these two profiles comprises preferred media content and an associated characteristics of a community.

With reference to FIG. 3 for ease of understanding, the third set of preference profiles has reference numeral 302, and the second set of preference profiles—also stored on the server—has reference numeral 301. The second set of preference profiles may be understood as all possibly selectable preference profiles on the server, where each of these preference profiles each has its own community characteristics, correspondingly, the third set of preference profiles is a subset of the second set of preference profiles, since the third set is selected from the second set by use of the first community characteristics as a selection criterion.

As an example, assume the following—also with reference to FIG. 3—that
1) preference profile, reference numeral 303 has community characteristics of age: 25 to 33 with profession as an Information Technology worker,
2) preference profile, reference numeral 304 has community characteristics of age: 34 to 40 with profession of an engineer or a baker,
3) preference profile, reference numeral 305 has community characteristics of age: 40 to 44 with profession of a carpenter, and
4) preference profile, reference numeral 306 has community characteristics of age: more than 44 years, with the profession as a lawyer.

And further assume that the first community characteristics have as only information “age between 25 and 44 years”, then—as a consequence of reference numeral 306 having community characteristics outside “age between 25 and 44 years”, i.e. the age of more than 44 years—the preference profile of reference numerals 306 will not be selected—but the preference profiles of reference numerals 303, 304 and 305 will be selected as the third set of preference profiles, which is shown in FIG. 3 by reference numeral 302.

In other words—continuing the example—the third preferred media content associated to the third set of preference profiles will then be the preferred media content of the summarized (pseudo) community of: Information Technology workers with the age from 25 to 33, engineers or bakers with the age from 34 to 40 and carpenters with the age from 40 to 44.

Generally, the third set of preference profiles matches, if possible, the first community characteristics received

In step 3000, the third set of preference profiles may be transferred from the server to the media system as a response to the reception of the first community characteristics.

In other words—still continuing the example—the third set of preference profiles will then subsequently be transferred to the media system from the server. This means that the media system now has the third preferred media content to be used for a recommendation in the next step. It also means, if the third set of preference profiles is used solely in the next step, the third set may give a subsequent recommendation based on the preferred media content of Information Technology workers with the age from 25 to 33, engineers or bakers with the age from 34 to 40 and carpenters with the age from 40 to 44.

To the contrary, it may be possible for the media system or for other media systems to transfer a preference profile (with associated user characteristics) to the server; as a consequence the server's number of available preference profiles may then be expanded. By use of several user characteristics, the server may then subsequently define a new community characteristic with associated categories of preferred media content.

In step 4000, media content on the media system may be recommended based on the third preferred media content of the received third set of preference profiles; the recommendation of media content may further be based on the first preferred media content of the first set of preference profiles already stored on the media system, and in all cases the recommendation need to take into account a media content available to the media system. The media content available to the media system was previously described by means of reference numeral 24 in FIG. 2.

In the recommendation process the processor of the media system, reference numeral 109 of FIG. 1 may, firstly consider said media content available to the media system, and, secondly, consider which preferred media content with respect to categories such as comedy, horror, sport, opera, news, etc that is comprised in the preferred media content of the set of preference profiles used, and finally, when there is a match between said media content available and at least one of said categories then the corresponding media content may be recommended to the user. The recommendation may be in the form of a message, a list, an icon, etc presented on the display (e.g. reference numeral 21 from FIG. 2) of the media system. The user may then, if desired, follow the recommendation i.e. select said corresponding media content for presentation on his media system or when the media system is a video recorder to record the recommended media content now or on a later predetermined time.

The user of the media system may choose to have media content recommended based on only the third preferred media content of the (newly) received third set of preference profiles; or the user may alternatively choose to have media content recommended based on the (earlier) first set of preference profiles previously stored on the media system, or alternatively to have media content recommended based of the combination of the (new) third and the (earlier) first set of preference profiles.

All these combinations may offer to the user the possibility to see what the media system can recommend.

When the media system media system is a TV, a so called EPG Electronic Program Guide may be used to generate a virtual channel, e.g. when the preference profile(s) selected is/are applied to the EPG, then the programs that most closely match the(se) profile(s) may be combined into a virtual channel available as a further channel on the TV.

If the media system media system is a Personal Video Recorder, the Electronic Program Guide may further be used to recommend which programs or channels the user should subsequently have recorded on said video.

When the media system media system is a radio, available songs matching the category(ies) of the preference profile(s) selected may be recommended on the radio.

In step 5000, the received third set of preference profiles may be stored on the media system to the first set of preference profiles. If the user of the media system in the foregoing step determined that the recommendation based on the third preferred media content was satisfactory, he may then desire to store the received third set of preference profiles to the first set of preference profiles; i.e.—subsequently—the first set of preference profiles will also comprise said third set of preference profiles.

As an option it may be possible that a received third set of preference profiles replaces the first preference profiles originally stored on the media system.

In step 6000, the first set of preference profiles may be modified and stored. The user may be dissatisfied with the recommendation and therefore desires to change the preferred media content associated to the first set of preference profiles; assume that the user changes points of interest—he no longer wishes to be recommended to see horror movies—he may then put ‘horror’ in the ‘disliked category’ in said preferred media content. Subsequently, he may the make his media system store the amended category associated to said first set of preference profiles of the preferred media content.

In step 7000, an information property, on the basis of a user input on the media system, may be sent to the server.

The information property may be used to manipulate and filter out a fourth preferred media content in step 8000.

The information property may comprise one of the following ways of data manipulation:
1) add extra weight to a preferred media content for a given preference profile on the server as compared to other preference profiles saved on the server,
2) add extra weight to a preferred media content for a given preference profile on the server as compared to other preference profiles saved on the media system,
3) add extra weight to a preferred media content for a given preference profile (e.g. belonging to the user himself) on the media system that diverges from the average of other preference profiles saved on the server,
4) add extra weight to a preferred media content for a given preference profile (e.g. belonging to the user himself) on the media system that diverges from the average of other preference profiles saved on the server,
5) add extra weight for a preferred media content associated to the preference profile of given family members (e.g. parents have more weight than children),
6) override one or more parts a preferred media content associated to a given preference profile of (e.g. use specific community characteristics as a criterion, e.g. sex=male, age=between 18 and 30 and in the preferred media content do not comprise a category such as sport, i.e. dislike sport.
   Correspondingly,—the opposite—to add less weight may equally be applied.
7) use other specific community characteristics as a criterion, e.g. a toplevel of a states USA, Europe, Russia, Asia, Australia, South America, South America, but only the Spanish-speaking.
8) inverting any given preference profile, i.e. what was disliked in the preferred media content is preferred and vice versa; whereby, of course a subsequently very different (reverse) recommendation may be given on the media system.

Corresponding to when some preference profiles are compared with another preference profile on the server in order to—to give more or less weight, to override, to invert, (as discussed above) etc.; a similar manipulations of data may be performed on the preference profiles of the media system.

In step 8000, a fourth set of preference profiles may be determined on the server; the fourth set of preference profiles comprises a corresponding fourth preferred media content. Said fourth preferred media content may be generated on basis of said information property from the foregoing step and on basis of the second set of preference profiles stored on the server.

Similar to step 1000 (and the following steps), where the selected first community characteristics were used to determine preferred media content; the information property may in this step be used—as was described in the foregoing—to manipulate and to filter the second set of preference profiles in order to determine said fourth preferred media content.

In step 9000, the fourth set of preference profile may be transferred from the server to the media system to the first set of preference profiles stored on the media system in response to the received information property. The fourth set of preference profiles is transferred to the media system from the server. This means that the media system now has the fourth preferred media content to be used for a further recommendation of media content in the next step.

In step 10000, further media content may be recommended on the media system based on the fourth preferred media content of the received fourth preference profile and the media content available to the media system. Similar to step 4000, a further media content recommendation may be determined based solely on the received fourth preference profile and on said available media content.

Usually, the method will start all over again as long as the media system and the server are properly exchanging preference profiles, community and user characteristics, etc. Otherwise, the method may terminate in step 11000, however, when the media system) and the server are powered again, the method may proceed from step 1000 again.

1. A method of recommending media content on a media system (103) by use of a first set (300) of preference profiles stored on the media system and a second set (301) of preference profiles stored on a server (101), wherein each preference profile of said two sets of preference profiles comprises preferred media content saved with characteristics of a community on the server, and saved with characteristics of a user on the media system, the method comprising the steps of:
transferring (1000) a selected first community characteristics (105) to the server from the media system;
determining (2000), on the server, a third set of preference profiles (302) with a third preferred media content from the second set of preference profiles, wherein the third set has characteristics matching the received first community characteristics;
transferring (3000) the third set of preference profiles from the server to the media system in response to the received first community characteristics; and
recommending (4000) media content (307) on the media system based on the third preferred media content of the received third set of preference profiles, based on, optionally, the first preferred media content of the first set of preference profiles stored on the media system and a media content available (24) to the media system.

2. A method according to claim 1, characterized in that the method further comprises the step of:
storing (5000) the received third set of preference profiles on the media system to the first set of preference profiles.

3. A method according to claim 1, characterized in that the method further comprises the step of:
modifying (6000) and storing the first set of preference profiles.

4. A method according to claim 1, characterized in that the method further comprises the sub-steps of:
sending (7000) an information property, on the basis of a user input on the media system, to the server;
determining (8000), on the server, a fourth set of preference profiles comprising a fourth preferred media content, wherein the fourth preferred media content is generated on basis of said information property and the second set of preference profiles stored on the server;
transferring (9000) the fourth preference profile from the server to the media system to the first set of preference profiles stored on the media system in response to the received information property; and
recommending (10000) further media content on the media system based on the fourth preferred media content of the received fourth preference profile and the media content available to the media system.

5. A method according to claim 1, characterized in that the media system is one from the group comprising TV, computer, personal video recorder, set-top box and radio.

6. A method according to claim 1, characterized in that the media content is one from the group comprising TV, video, a radio broadcasting, Internet TV and Internet sites.

7. A computer system for performing the method according to claim 1.

8. A computer program product comprising program code means stored on a computer readable medium for performing the method of claim 1 when said computer program is run on a computer.

9. A media system for recommending media content by use of a first set of preference profiles stored on the media system and a second set of preference profiles stored on a server, said media system comprising:
means for (23) transferring a selected first community characteristics (105) to the server;
means for receiving (23), determined on the server, a third set of preference profiles with a third preferred media content from the second set of preference profiles, wherein the third set has characteristics matching the received first community characteristics; and
means for recommending (109) media content based on the third preferred media content of the received third set of preference profiles, based on, optionally, the first preferred media content of the first set of preference profiles stored on the media system and a media content available to the media system.

10. A media system according to claim 9, characterized in that the media system further comprises:
means for (109) storing the received third set of preference profiles system to the first set of preference profiles.

11. A media system according to claim 9, characterized in that the media system further comprises:
means for (23) sending an information property, on the basis of a user input, to the server;
means for (23) receiving, determined on the server, a fourth set of preference profiles comprising a fourth preferred media content, wherein the fourth preferred media content is generated on basis of said information property and the second set of preference profiles stored on the server; and
means for recommending (109) further media content based on the fourth preferred media content of the received fourth preference profile and the media content available to the media system.
